(19) United States
(12) Patent Application Publication
(10) Pub. No.: US 2011/0258318 A1
(43) Pub. Date: Oct. 20, 2011

(54) NETWORK DEVICE AND METHOD FOR DYNAMICALLY ALLOCATING CONNECTION RESOURCES

(75) Inventor: HUA-JUI PENG, Tu-Cheng (TW)

(73) Assignee: HON HAI PRECISION INDUSTRY CO., LTD., Tu-Cheng (TW)

(21) Appl. No.: 12/913,781

(22) Filed: Oct. 28, 2010

(30) Foreign Application Priority Data
Apr. 16, 2010 (CN) 201010148641.3

(51) Int. Cl. G06F 15/173

(52) U.S. Cl. 709/226

(57) ABSTRACT

A network device receives a new connection request from one of a plurality of clients, and determines whether all connection resources are unavailable. If all the connection resources are unavailable, the network device further determines whether a difference between connection resources occupied by the one client and a connection resource hog client is less than a determined threshold. The connection resource hog client is another one of the plurality of clients which occupies most connection resources. If the difference is less than the determined threshold, the network device releases a first connection resource with a predefined priority that is found in the connection resources occupied by the one client, and allocates the released connection resource to the one client according to the new connection request.

### BACKGROUND

1. Technical Field

The present disclosure relates to network communications, and more particularly to a network device and a method for dynamically allocating connection resources of the network device.

2. Description of Related Art

Due to rapid developments in the Internet technology, hosts using Internet protocol (IP) addresses have increased dramatically, resulting in a lack of available IP addresses. Accordingly, network address translation (NAT) has been introduced to resolve the problem.

Under NAT management, one broadband network line can simultaneously provide Internet service for a plurality of clients. However, with the development of network technologies, client-server models for file transfer have been replaced with peer to peer (P2P) software-based systems, with connection resources increasing commensurately.

Thus, a problem arises in which connection resources can be largely occupied by a single client of the P2P software, such that some clients cannot access Internet service. In detail, FIG. 7 shows client I using the P2P software occupying the majority of connection resources and client II occupying remaining connection resources, such that client I has his/her new connection request to the Internet rejected. For example, the new connection request from client I to the Internet is rejected because client I utilizes the P2P software to watch movies.

### BRIEF DESCRIPTION OF THE DRAWINGS

The details of the disclosure, both as to its structure and operation, can best be understood by referring to the accompanying drawing, in which like reference numbers and designations refer to like elements.

FIG. 1 is a schematic diagram of an application environment of a network device in accordance with the present disclosure;

FIG. 2 is a schematic diagram of functional modules of one embodiment of a network device in accordance with the present disclosure;

FIG. 3 is a schematic diagram showing a mapping relation between applications and port numbers in according with one embodiment of the present disclosure;

FIG. 4 is a schematic diagram showing a network device dynamically allocating connection resources in accordance with one embodiment of the present disclosure;

FIG. 5 is a schematic diagram showing a network device dynamically allocating connection resources in accordance with another embodiment of the present disclosure;

FIG. 6 is a flowchart of one embodiment of a method for dynamically allocating connection resources in accordance with the present disclosure; and

FIG. 7 is a schematic diagram showing majority of connection resources being occupied by a client and a new connection request being rejected.

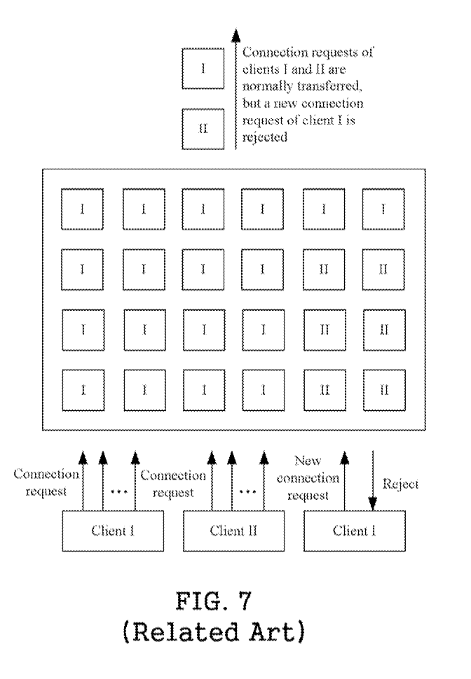

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

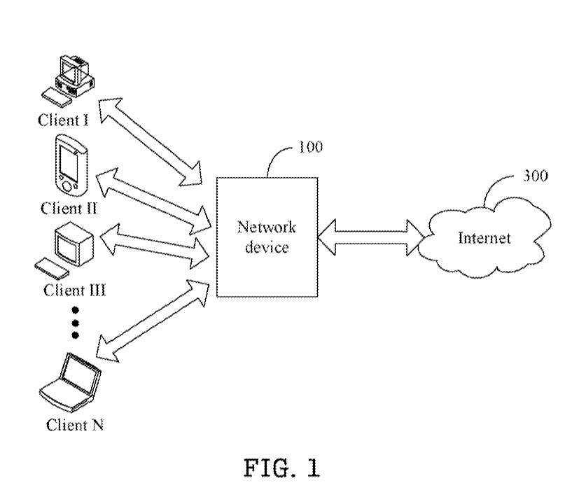

FIG. 1 is a schematic diagram of an application environment of a network device 100 in accordance with the present disclosure. In one embodiment, the network device 100 is connected between a plurality of clients I, II . . . N and the Internet 300, and is operable to provide network connection service to the plurality of clients I, II . . . N. That is, the network device 100 transfers Internet connection requests from the plurality of clients I, II . . . N to the Internet 300.

In one example, the network device 100 may be a network address translation (NAT), a firewall, an Internet protocol (IP) sharing device, or another device translating IP addresses. The plurality of client I, II . . . N may include personal computers, notebook computers, mobile Internet devices (MIDs), or other communication devices that can connect to the Internet 300.

In one embodiment, the network device 100 dynamically allocates connection resources of the network device 100 to the plurality of clients I, II . . . N. In detail, if a new connection request is transmitted from a first client (one of the plurality of clients I, II . . . N) to the Internet 300, and the connection resources are largely occupied by a second client (a connection resource hog client of the plurality of clients I, II . . . N), the network device 100 releases a connection resource with a predefined priority from connection resources occupied by the first client or the second client, and allocates the released connection resource to the first client for the new connection request. It should be understood that a resource hog is defined as a hardware and/or software system using and/or occupying most or a majority of a system's resources.

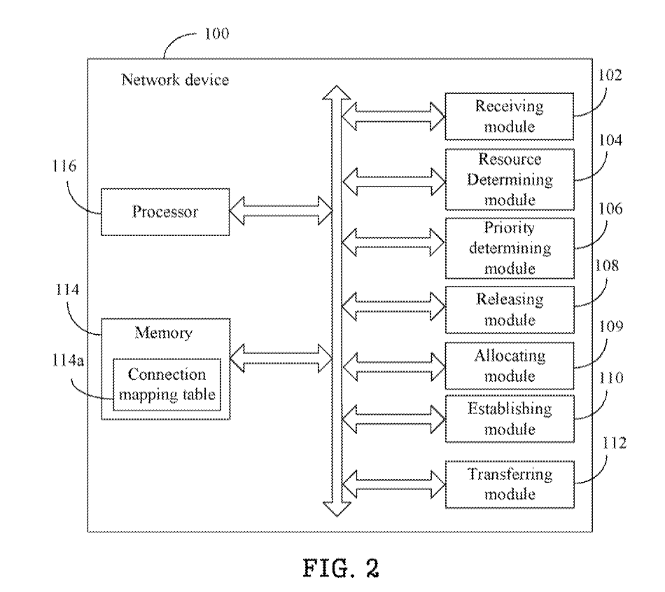

FIG. 2 is a schematic diagram of functional modules of one embodiment of the network device 100 in accordance with the present disclosure. In one embodiment, the network device 100 includes a receiving module 102, a resource determining module 104, a priority determining module 106, a releasing module 108, an allocating module 109, a memory 114, and at least one processor 116. The modules 102-109 may comprise computerized code in the form of one or more programs that are stored in the memory 114. The computerized code includes instructions that are executed by the at least one processor 116 to provide functions for modules 102-109.

The receiving module 102 is operable to receive a new connection request from a first client. In one embodiment, the first client is one of the plurality of clients I, II . . . N.

The resource determining module 104 is operable to determine whether all connection resources of the network device 100 are unavailable. The allocating module 109 is operable to allocate remaining connection resources to the first client according to the new connection request upon the condition that one or more of the connection resources of the network device 100 are available.

The resource determining module 104 is operable to determine whether a difference between connection resources occupied by the first client and a second client (a connection resource hog client) is less than a determined threshold upon the condition that all the connection resources of the network device are unavailable. In one example, the network device 100 may provide 1024 connection resources, and the determined threshold may be 50 connection resources.

In one embodiment, the second client (the connection resource hog client) is one of the plurality of clients I, II . . . N which occupies the most connection resources. The first client and the second client may be different clients if the first client does not occupy the most connection resources in the plurality of clients I, II . . . N. In another embodiment, the first client and the second client may be a same client if the first client occupies the most connection resources in the plurality of clients I, II . . . N.

The priority determining module 106 is operable to determine whether a first connection resource with a predefined priority is found in the connection resources occupied by the first client upon the condition that the difference is less than the determined threshold.

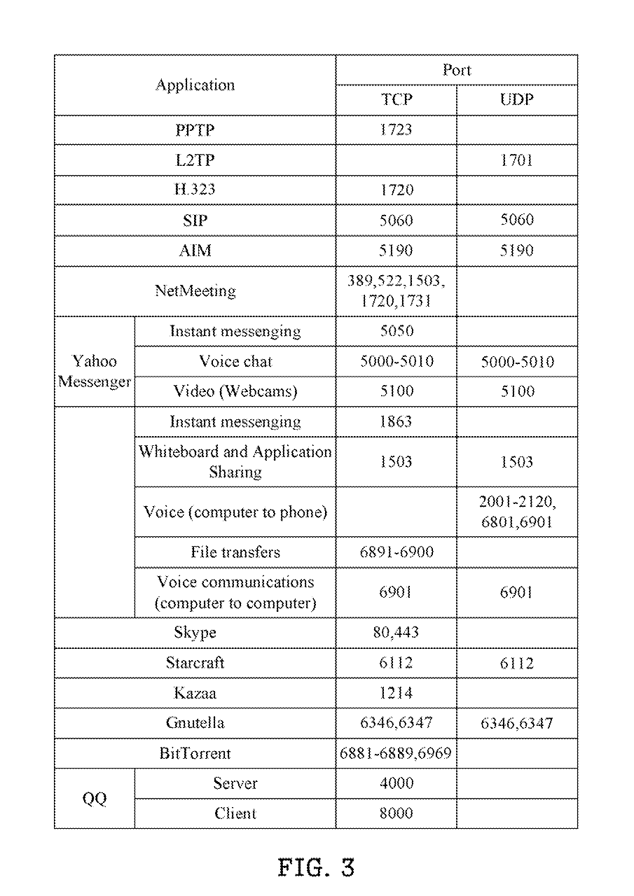

In one embodiment, connections conforming to one of the following four conditions are determined to be connection resources with a high priority, and connections not conforming to any one of the following four conditions are determined to be connection resources with a predefined priority (a low priority). The four conditions include: (1) connections established by the Internet 300; (2) connections established by the plurality of clients I, II . . . N and conforming to a port forwarding rule of the network device 100; (3) connections with destination port numbers 1-1024 established by the plurality of clients I, II . . . N; (4) connections, with destination port numbers conforming to a mapping relation shown in FIG. 3, established by the plurality of clients I, II . . . N. In one embodiment, the first connection resource with the predefined priority is a connection resource not conforming to the previous four conditions. The priority determining module 106 determines whether a connection resource not conforming to the previous four conditions is found in the connection resources occupied by the first client. If a connection resource not conforming to the previous four conditions is found in the connection resources occupied by the first client, the priority determining module 106 determines the first connection resource with the predefined priority is found.

The releasing module 108 is operable to release the first connection resource with the predefined priority that is found in the connection resources occupied by the first client. The allocating module 109 is operable to allocate the released connection resource to the first client according to the new connection request.

The allocating module 109 is further operable to reject the new connection request upon the condition that the first connection resource with the predefined priority is not found in the connection resources occupied by the first client.

The priority determining module 106 is further operable to determine whether a second connection resource with a predefined priority is found in the connection resources occupied by the second client upon the condition that the difference is greater than or equal to the determined threshold. In one embodiment, the second connection resource with the predefined priority is a connection resource not conforming to the previous four conditions. The priority determining module 106 determines whether a connection resource not conforming to the previous four conditions is found in the connection resources occupied by the second client. If a connection resource not conforming to the previous four conditions is found, the priority determining module 106 determines the second connection resource with the predefined priority is found.

The releasing module 108 is further operable to release the second connection resource with the predefined priority that is found in the connection resources occupied by the second client. The allocating module 109 is further operable to allocate the released connection resource to the first client according to the new connection request.

The allocating module 109 is further operable to reject the new connection request upon the condition that the second connection resource with the predefined priority is not found in the connection resources occupied by the second client.

In one embodiment, the network device 100 may further include an establishing module 110 and a transferring module 112. The establishing module 110 is operable to establish a connection entry for the first client according to the new connection request. The connection entry comprises a mapping relationship between a private Internet protocol (IP) address and a public IP address of the first client. The transferring module 112 is operable to transform the private IP address to the public IP address of the first client according to the connection entry of the first client, and transfer the new connection request from the first client to the Internet 300 according to the public IP address.

In one embodiment, the memory 114 may further include a connection mapping table 114a operable to store the connection entry of the first client.

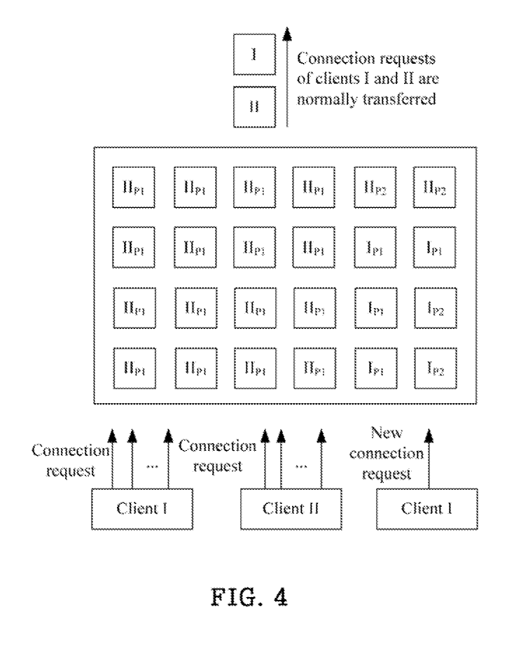

FIG. 4 is a schematic diagram showing the network device 100 dynamically allocating connection resources in accordance with one embodiment of the present disclosure. In one embodiment, P1 and P2 indicate a high priority and a low priority (a predefined priority), respectively.

In one embodiment, clients I and II initially send connection requests to the network device 100, where the network device 100 allocates connection resources to clients I and II, and transfers the connection requests from clients I and II to the Internet 300. In one example, client I is using a peer to peer (P2P) software, which occupies most of the connection resources. Client II is using a software other than the PSP software, such as a hyper text transfer protocol (HTTP) software, which occupies only a small portion of the connection resources.

Subsequently, client I sends a new connection request to the network device 100, but no connection resource remains, having been previously occupied by clients I and II. In such a case, the network device 100 determines whether a difference between connection resources occupied by clients I and II is less than a determined threshold because client II occupies most connection resources.

If the difference is less than the determined threshold, the network device 100 determines whether a first connection resource with a predefined priority is found in the connection resources occupied by client I. If the first connection resource with the predefined priority is found in the connection resources occupied by client I, the network device 100 releases the first connection resources with the predefined priority. Then the network device 100 allocates the first connection resource with the predefined priority to client I according to the new connection request.

Conversely, if the difference is not less than the determined threshold, the network device 100 determines whether a second connection resource with a predefined priority is found in the connection resources occupied by client II. If the second connection resource with the predefined priority is found in the connection resources occupied by client II, the network device 100 releases the second connection resources with the predefined priority. Then the network device 100 allocates the second connection resources with the predefined priority to client I according to the new connection request.

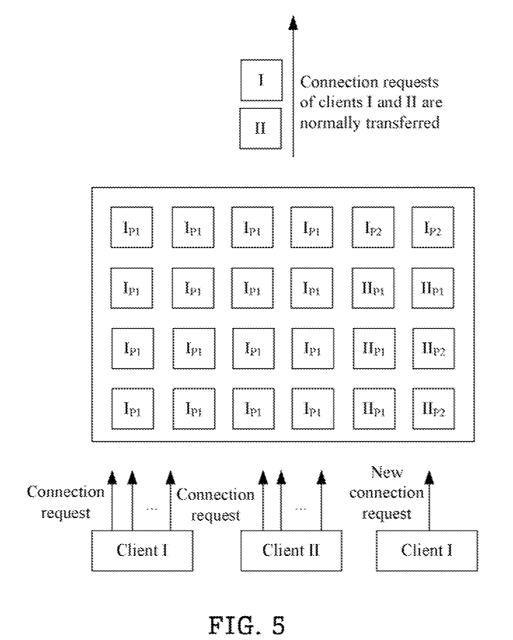

FIG. 5 is a schematic diagram showing the network device 100 dynamically allocating connection resources in accordance with another embodiment of the present disclosure. In one embodiment, P1 and P2 indicate a high priority and a low priority (a predefined priority), respectively.

In one embodiment, clients I and II initially send connection requests to the network device 100, where the network device 100 allocates connection resources to clients I and II, and transfers the connection requests from clients I and II to the Internet 300. In one example, client I is using a peer to peer (P2P) software, which occupies most of the connection resources. Client II is using a software other than the PSP software, such as a hyper text transfer protocol (HTTP) software, which occupies only a small portion of the connection resources.

Subsequently, client I sends a new connection request to the network device 100, but no connection resource remains, having been previously occupied by clients I and II. In such a case, the network device 100 determines whether a first connection resource with a predefined priority is found in the connection resources occupied by client I because client I occupies most connection resources.

If the first connection resource with the predefined priority is found in the connection resources occupied by client I, the network device 100 releases the first connection resource with the predefined priority. Then the network device 100 allocates the first connection resource with the predefined priority to client I according to the new connection request.

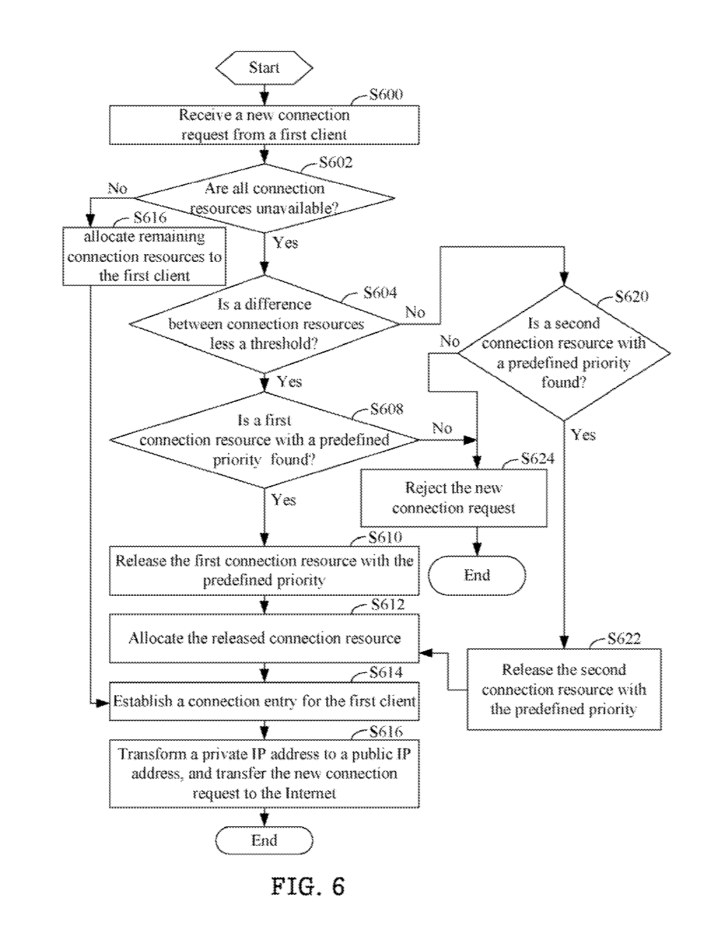

FIG. 6 is a flowchart of one embodiment of a method for dynamically allocating connection resources in accordance with the present disclosure. The method may be embodied in the network device 100, and is executed by the functional modules such as those of FIG. 2. Depending on the embodiment, additional blocks may be added, others deleted, and the ordering of the blocks may be changed while remaining well within the scope of the disclosure.

In block S600, the receiving module 102 receives a new connection request from a first client. In one embodiment, the first client is one of the plurality of clients I, II . . . N shown in FIG. 1.

In block S602, the resource determining module 104 determines whether all connection resources of the network device 100 are unavailable.

If one or more of the connection resources are available, the allocating module 109 allocates remaining connection resources to the first client according to the new connection request as shown in block S616.

If all the connection resources are unavailable, in block S604, the resource determining module 104 determines whether a difference between connection resources occupied by the first client and a second client is less than a determined threshold. In one example, the network device 100 may provide 1024 connection resources, and the determined threshold may be 50 connection resources. The second client occupies most connection resources in the plurality of clients I, II . . . N.

If the difference is less than the determined threshold, in block S608, the priority determining module 106 determines whether a first connection resource with a predefined priority is found in the connection resources occupied by the first client.

If the first connection resource with the predefined priority is found in the connection resources occupied by the first client, in block S610, the releasing module 108 releases the first connection resource with the predefined priority.

In block S612, the allocating module 109 allocates the first connection resource with the predefined priority to the first client according to the new connection request.

If the first connection resource with the predefined priority is not found in the connection resources occupied by the first client, in block S624, the allocating module 109 rejects the new connection request.

If the determining result of block S604 is that the difference is greater than or equal to the determined threshold, the priority determining module 106 determines whether a second connection resource with a predefined priority is found in the connection resources occupied by the second client as shown in block S620.

If the second connection resource with the predefined priority is found in the connection resources occupied by the second client, in block S622, the releasing module 108 releases the second connection resource with the predefined priority.

In block S612, the allocating module 109 allocates the second connection resource with the predefined priority to the first client according to the new connection request.

If the second connection resource with the predefined priority is not found in the connection resources occupied by the second client, in block S624, the allocating module 109 rejects the new connection request.

In block S614, the establishing module 110 establishes a connection entry for the first client according to the new connection request. The connection entry comprises a mapping relationship between a private Internet protocol (IP) address and a public IP address of the first client.

In block S616, the transferring module 112 transforms the private IP address to the public IP address of the first client according to the new connection entry, and transfers the new connection request from the first client to the Internet 300 according to the public IP address.

Thus, the network device 100 can transfer the new connection request from the first client to the Internet 300 even if the second client utilizes the P2P software to occupy majority of the connection resources. In detail, the network device 100 determines whether the different between the connection resources occupied by the first client and the second client is less than the determined threshold so as to determine whose connection resource with a predefined priority should be released, such that the released connection resource with the predefined priority is allocated to the first client.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A network device for dynamically allocating connection resources for a plurality of clients, the network device comprising:
at least one processor;
memory;
one or more programs that are stored in the memory and are executed by the at least one processor, the one or more programs comprising:
a receiving module operable to receive a new connection request from one of the plurality of clients;
a resource determining module operable to determine whether all connection resources of the network device are unavailable, and further determine whether a difference between connection resources occupied by the one client and a connection resource hog client is less than a determined threshold upon the condition that all connection resources of the network device are unavailable, wherein the connection resource hog client is another one of the plurality of clients which occupies most connection resources of the network device;
a priority determining module operable to determine whether a first connection resource with a predefined priority is found in the connection resources occupied by the one client upon the condition that the difference is less than the determined threshold;
a releasing module operable to release the first connection resource with the predefined priority that is found in the connection resources occupied by the one client; and
an allocating module operable to allocate the released connection resource to the one client according to the new connection request.

2. The network device of claim 1, wherein the connection resources comprise network connections between the plurality of clients and the Internet.

3. The network device of claim 1, wherein the allocating module is further operable to allocate remaining connection resources to the one client according to the new connection request upon the condition that one or more of the connection resources of the network device are available.

4. The network device of claim 1, wherein the allocating module is further operable to reject the new connection request upon the condition that the first connection resource with the predefined priority is not found in the connection resources occupied by the one client.

5. The network device of claim 1, wherein:
the priority determining module is further operable to determine whether a second connection resource with a predefined priority is found in the connection resources occupied by the connection resource hog client upon the condition that the difference is greater than or equal to the determined threshold;
the releasing module is further operable to release the second connection resource with the predefined priority that is found in the connection resources occupied by the connection resource hog client; and
the allocating module is further operable to allocate the released connection resource to the one client according to the new connection request.

6. The network device of claim 5, wherein the allocating module is further operable to reject the new connection request upon the condition that the second connection resource with the predefined priority is not found in the connection resources occupied by the connection resource hog client.

7. The network device of claim 1, further comprising:
an establishing module operable to establish a connection entry for the one client according to the new connection request, wherein the connection entry comprises a mapping relationship between a private Internet protocol (IP) address and a public IP address of the one client; and
a transferring module operable to transform the private IP address to the public IP address of the one client according to the connection entry of the one client, and transfer the new connection request from the one client to the Internet according to the public IP address.

8. The network device of claim 7, wherein the memory further comprises a connection mapping table operable to store the connection entry of the one client.

9. A method of a network device for dynamically allocating connection resources for a plurality of clients, the method comprising:
receiving a new connection request from one of the plurality of clients;
determining whether all connection resources of the network device are unavailable;
determining whether a difference between connection resources occupied by the one client and a connection resource hog client is less than a determined threshold if all connection resources are unavailable, wherein the connection resource hog client is another one of the plurality of clients which occupies most connection resources of the network device;
determining whether a first connection resource with a predefined priority is found in the connection resources occupied by the one client if the difference is less than the determined threshold;
releasing the first connection resource with the predefined priority that is found in the connection resources occupied by the one client; and
allocating the released connection resource to the one client according to the new connection request.

10. The method of claim 9, wherein the connection resources comprise network connections between the plurality of clients and the Internet.

11. The method of claim 9, further comprising allocating remaining connection resources to the one client according to the new connection request if one or more of the connection resources are available.

12. The method of claim 9, further comprising rejecting the new connection request if the first connection resource with the predefined priority is not found in the connection resources occupied by the one client.

13. The method of claim 9, further comprising:
determining whether a second connection resource with a predefined priority is found in the connection resources occupied by the connection resource hog client if the difference is greater than or equal to the determined threshold;
releasing the second connection resource with the predefined priority that is found in the connection resources occupied by the connection resource hog client; and
allocating the released connection resource to the one client according to the new connection request.

14. The method of claim 13, further comprising rejecting the new connection request if the second connection resource with the predefined priority is not found in the connection resources occupied by the connection resource hog client.

15. The method of claim 9, further comprising:
establishing a connection entry for the one client according to the new connection request, wherein the connection entry comprises a mapping relationship between a private Internet protocol (IP) address and a public IP address of the one client; and
transforming the private IP address to the public IP address of the one client according to the new connection entry of the one client; and
transferring the new connection request from the one client to the Internet according to the public IP address.
